(19) United States
(12) Patent Application Publication
(10) Pub. No.: US 2003/0202101 A1
(43) Pub. Date: Oct. 30, 2003

(54) Method for accessing and controlling a remote camera in a networked system with multiple user support capability and integration to other sensor systems

(76) Inventors: David A. Monroe, San Antonio, TX (US); Adrian Alvarado, San Antonio, TX (US); John M. Baird, San Antonio, TX (US); Raymond G. Hollida, San Antonio, TX (US)

Correspondence Address: Robert C. Curfiss, Jackson Walker LLP, Suite 2100, 112 E. Pecan, San Antonio, TX, 78205, US

(21) Appl. No.: 10/134,413

(22) Filed: Apr. 29, 2002

(51) Int. Cl. H04N 7/18

(52) U.S. Cl. 348/156

(57) ABSTRACT

A method for presenting complex camera controls for a plurality of cameras to a user is dynamically based on the cursor position and on the GUI focus. The controls may be presented to a plurality of users, such as on an IP network, and the status of the camera and controls may also be presented dynamically and simultaneously to a plurality of users on the network. Network delays, such as IP network propagation and latency, create camera control user interface difficulties, and methods for mitigating the delays by use of caching of camera status, methods of use of indicators showing adjusting status, and methods to command camera positioning that do not require real-time visual feedback are defined. Methods of defining and activating auto-panning functions and preset tilt/pan/focus functions are defined, and the methods of reporting status to a plurality of users. In addition, a method of linking activation of camera presets to other systems is established.

### BACKGROUND OF THE INVENTION

1. Field of the Invention

The subject invention is generally related to on screen camera controls and is specifically directed to a system for managing both access to and control of remote camera by multiple users in a networked system.

2. Discussion of the Prior Art

Electronic, remote control of cameras is well known. Typically, a joystick is provided and hardwired to the remote camera. The user will look through a view-finder or at a monitor and control the camera with the joy stick to control pan/tilt/zoom and other functions, including but not limited to light, position and focus adjustments. This system works well for cameras with single control stations and where the hard wiring permits the camera to respond in a very near real time basis.

The systems of the prior art are not useful for cameras that may be simultaneously accessed by multiple users and/or may be delayed in response to control signals due to lag time caused by signal processing including network latency. In such cases the camera may be subjected to conflicting control, and the ability to accurately pan/tilt/zoom on a target may be impaired.

### SUMMARY OF THE INVENTION

The subject invention is specifically directed to a method for controlling cameras in a networked system to avoid conflict between control signals from multiple users. The subject invention is also directed to a control methodology that permits compensation for the signal processing lag time in digitized, networked systems.

The control methodology of the invention establishes a user hierarchy for granting single user control when multiple users may be accessing the same camera on a system. Basically, when two or more equal users access the camera, the user with the highest authority controls the camera actions. Whenever a user with higher authority seeks access, he will bump lower authority users. When a controlling user terminates his access the next highest, or if equal the next in time, user will be granted control. The user having control may be identified to all other stations during the period of control.

The “aiming” issues are resolved by aiming the camera at an electronic target on a display screen using point-and-click mouse technology. The camera then adjusts to and centers on the electronic target. In the preferred embodiment crosshairs are used to identify the center of the target. By using the crosshairs to identify the target center, the camera reacts to a selected point rather than to servo commands. This eliminates the overshoot resulting from signal processing delays.

A Graphic User Interface (GUI) is provided with a map including icons representing each camera. Each camera icon shows the location and the direction of the camera. Pan/tilt/zoom cameras have icons that follow the direction of the camera. Such cameras may be instructed to return to a home position after a pre-selected period of dormancy.

It is an object of the invention to provide for dynamically selecting viewing of and access to the controls for any controllable camera when the mouse or joystick (cursor) is placed upon top of the video image presented on the monitor screen from that camera.

It is an object of the invention to provide for dynamically selecting viewing of and access to the controls for any controllable camera when the mouse or joystick (cursor) is placed upon top of the map icon for that camera.

It is an object of the invention to provide for dynamically selecting viewing of and access to the controls for any controllable camera when the mouse or joystick (cursor) is placed upon top of name of that camera.

It is a further object and feature of the invention to report the status of a camera execution of an operation such as tilt, pan, zoom or focus.

It is an object and feature of the invention to report the status of a camera execution of an operation, such as tilt, pan, zoom or focus, to all users on the network who are observing the camera with an appropriate icon.

It is an object and feature of the invention to show the position of controls of a camera dynamically to all users on a network who are observing that camera.

It is an object and feature of the invention to use GUI such as slider bars to indicate and control camera features.

It is an object and feature of the invention to show on the GUI the “go-to” position of the camera control as selected by the user, and dynamically moving indicator as the camera responds to the command.

It is an object and feature of the invention to show on the GUI the “go-to” position of the camera control as selected by the user, and dynamically moving indicator as the camera responds to the command displayed to a plurality of users subject to network delays.

It is a further object of the invention to cache the data for a camera that the user may control such that the controls may be immediately viewed, and be not subject to network delays prior to viewing of controls.

It is a further object of this invention to determine which controls need to be cached in order to provide immediate access to the controls.

It is a further object of this invention to cache the control data at the server.

It is a further object of this invention to cache the control data at the monitor station.

It is an object and feature of this invention to utilize a computer joy-stick, such as a game controller, attached to a monitor station computer to control remote cameras over an IP network, including tilt, pan, zoom, focus.

It is an object and feature of this invention to utilize a joy-stick, such as a game controller, attached to a monitor station computer to control remote cameras over an IP network, including tilt, pan, zoom, focus and report the resulting adjustment of the camera video on the monitor station computer display.

It is an object and feature of this invention to utilize a joy-stick, such as a game controller, attached to a monitor station computer to control remote cameras over an IP network, including tilt, pan, zoom, focus and report the resulting adjustment of the camera controls on the monitor station computer display.

It is an object and feature of this invention to log the position information relative to a camera, i.e. tilt, pan, and zoom, on a database, such that a stored camera image or stream can be correlated to the position of the camera for that exact moment in time.

It is an object and feature of this invention to be able to ‘browse’ the database and review historical images or image/video streams and have the associated historical camera position information for that camera presented synchronized with the images or image/video streams.

It is an object and feature of this invention to log all camera controls, i.e. day/night, brightness, aperture, contrast, hue, saturation, modes, and the like, on a database, such that a stored camera image or stream can be correlated to the position of the camera for that exact moment in time.

It is an object and feature of this invention to be able to ‘browse’ the database and review historical images or image/video streams and have all of associated historical camera controls for that camera, i.e. day/night, brightness, aperture, contrast, hue, saturation, modes, and the like, presented synchronized with the images or image/video streams.

It is an object and feature of the subject invention to provide for managed access and control of a networked camera subject to control by a plurality of users.

It is an object and feature of the subject invention to provide for managed access and control of a networked camera subject to control by a plurality of users by use of an IP network.

It is an object and feature of the subject invention to provide a hierarchy system for establishing whom of a plurality of simultaneous users is granted control.

It is an object and feature of this invention to provide for display of status of a networked camera to a plurality of users.

It is an object and feature of this invention to display the identity of the user who is controlling a camera at a given time to a plurality of users.

It is also an object and feature of the subject invention to provide for accurate aiming of a camera at the remote location.

It is a further object and feature of the subject invention to provide compensation for the delay caused by signal processing and network latency, permitting accurate aiming of the camera by establishing a target within the camera's current field of view, for the camera to find.

It is an object and feature of the subject invention to provide calculation of the specified “move-to” position by calculation including the zoom setting.

It is an object and feature of the subject invention to provide calculation of the specified “move-to position” by calculation including the zoom setting by use of a table to correct for non-linearity of the zoom optics.

It is an object and feature of the subject invention to provide camera icons on a map defining the location and direction of a camera.

It is a further object and feature of the invention to provide animated icons on the GUI showing that the camera is being adjusted, such as tilt, pan, zoom, focus, light level adjustment or the like.

It is a further object and feature of the subject invention to provide camera icons on a GUI for defining the location and direction of a camera on a system map.

It is a further object and feature of the subject invention to provide a dynamic field of view indication, such as by a pair or angular lines, showing the current field of view of the camera.

It is a further object and feature of this invention to highlight on the map the area that is in the field of view of the camera.

It is a further object and feature of the invention to highlight on the map, when a floor plan, the area that is in the field of view as limited by walls, objects and obstructions.

It is a further object and feature of the invention to indicate, on the map, a line depicting the centerline of the camera's field of view.

It is a further object and feature of the invention to provide an improved user means for controlling the camera, wherein the user clicks a spot on the map, and a selected camera rotates so as to align it's field-of-view centerline with the user-selected spot.

It is a further object and feature of the invention to provide an improved user means for controlling the camera, wherein the user clicks a spot on the map, and all cameras capable of viewing that spot rotate so as to align their respective fields of view centerlines with the user-selected spot.

It is an object and feature of this invention to provide control of a camera to automatically pan left and right at a predetermined rate.

It is an object and feature of this invention to provide controls for setting the left stop, the right stop, or the center position and the panning excursion, or any other method of defining the range of the automatic pan operation.

It is an object and feature of this invention to provide controls for setting the automatic panning rate.

It is an object and feature of this invention to provide a default position to position the camera to when auto-panning is disabled.

It is an object and feature of this invention to provide a dynamic screen indication that shows the location of the panning camera in real-time.

It is an object and feature of this invention to provide a dynamic screen indication that shows the location of the panning camera in real-time that is synchronized with the displayed camera video, compensating for network delays and latency.

It is an object and feature of this invention to provide a dynamic screen indication that shows the location of the panning camera in real-time, subject to network delays and latency, to a plurality of monitor stations.

It is an object and feature of this invention to provide for a plurality of automatic panning modes, with user selection of modes and indication of the mode that is camera to scan a more complex field of view.

It is an object and feature of this invention to provide a mode with a user definable ‘friendly’ name.

It is an object and feature of the invention to allow any authorized user on the network to select a mode.

It is an object and feature of this invention to provide network wide indication of the selected mode to all users that are viewing this camera.

It is an object and feature of this invention to provide for combined automatic tilting and/or panning and/or zooming over a prescribed pattern, thus allowing the camera to scan in a complex pattern to cover any size and shape field of view.

It is the object of this invention to provide for additional automatic focusing, light adjustments, and any other camera parameters, to further optimize the camera video quality while scanning a complex field of view.

It is an object and feature of this invention to provide for a user interface to “train” the system on the pattern that is desired for the camera to scan, including the tilt, pan, and other camera controls that may further optimize camera video quality while scanning.

It is an object and feature of this invention to provide a dynamic screen indication that shows the settings of the scanning camera controls in real-time.

It is an object and feature of this invention to provide a dynamic screen indication that shows the status of the camera controls in real-time that is synchronized with the displayed camera video, compensating for network delays and latency.

It is an object and feature of this invention to provide a dynamic screen indication that shows the status of the camera controls in real-time, subject to network delays and latency, to a plurality of monitor stations.

It is an object and feature of this invention to provide for a plurality of automatic scanning modes, with user selection of modes and indication of the mode that is selected.

It is an object and feature of this invention to provide a mode with a user definable ‘friendly’ name.

It is an object and feature of the invention to allow any authorized user on the network to select a mode.

It is an object and feature of this invention to provide network wide indication of the selected mode to all users that are viewing this camera.

It is an object and feature of this invention to provide preset positions for tilt, pan, zoom, focus, light levels, and all other camera parameters that may be controlled to improve camera imagery.

It is an object and feature of the invention to provide a user interface to set the parameters of the camera desired for each of the preset positions.

It is an object and feature of the invention to identify a preset with a user definable ‘friendly’ name.

It is an object and feature of the invention to allow any authorized user on the network to select a preset.

It is an object and feature of this invention to provide network wide indication of the selected preset to all users that are viewing this camera.

It is an object and feature of this invention to allow other sensors and systems to provide a ‘trigger’ signal to command the camera to go to a preset.

It is an object and feature of this invention to allow other sensors and systems to provide a ‘trigger’ signal to command the camera to go to a preset with commands being sent over and IP network.

It is an object and feature of this invention to allow other sensors and systems to provide a ‘trigger’ signal to command the camera to go to a preset by translation of trigger signals from the ‘third party’ sensors and systems to a signal that will select a certain preset.

Other objects and features of the invention will be readily apparent from the accompanying drawings and detailed description of the preferred embodiment.

### BRIEF DESCRIPTION OF THE DRAWINGS

FIG. 1 is an illustration of a system including the features of the subject invention.

FIG. 2 is a representative Graphical User Interface (GUI) as displayed at one of the operator's consoles.

FIG. 3 is an illustration of a typical user authorization hierarchy for multiple users.

FIG. 4 is an illustration of implementation of a method in accordance with the hierarchy established in FIG. 3.

FIG. 5 is a GUI with a facility map and a display area of a scene captured by a selected camera.

FIG. 6 is an illustration showing a GUI map depicting a camera and depicts its field of view, with the camera field-of-view centerline shown on the map and a spot.

### DETAILED DESCRIPTION OF THE PREFERRED EMBODIMENT

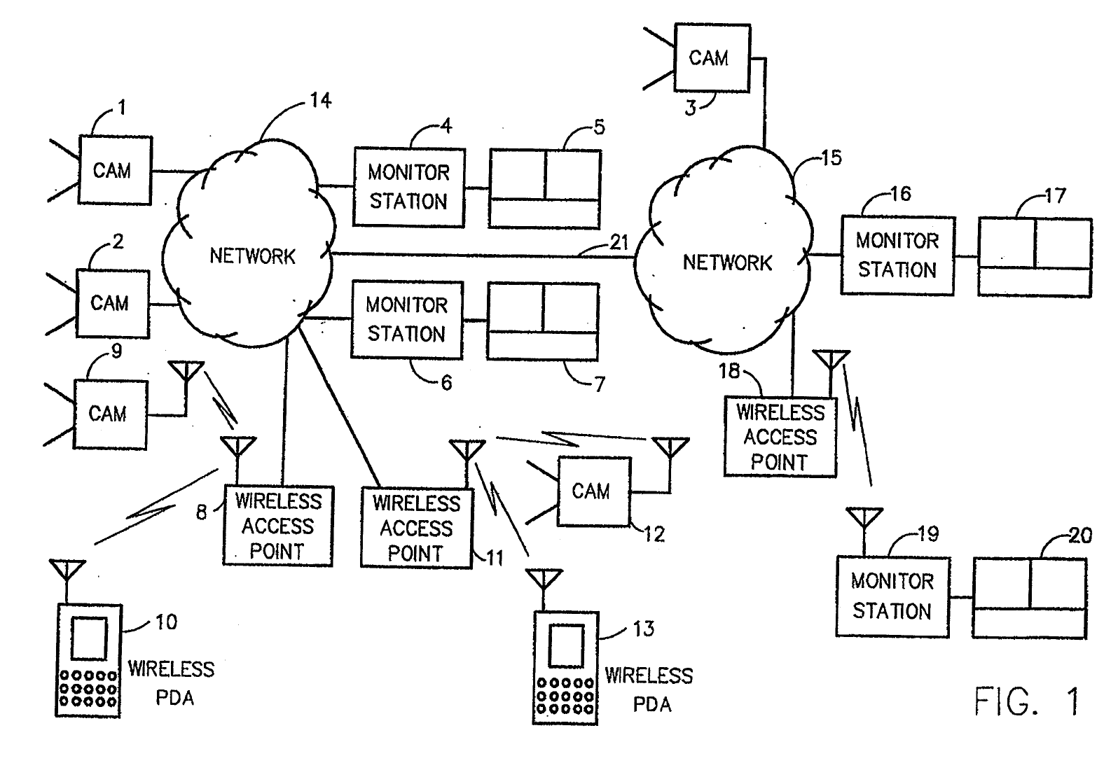

The system illustrated in FIG. 1 is consistent with a surveillance system containing a plurality of video cameras as described in copending applications of David A. Monroe, one of the named inventors of this application, Ser. Nos. 09/594,041 and 09/593,361 filed on Jun. 14, 2000, incorporated herein by reference. As shown in FIG. 1 the system includes a wired camera 1 for providing a video signal to the network 14. A plurality of cameras may be employed, such as camera 2 and a wireless camera 9. The wireless camera 9 is connected to the network 14 via a wireless access point 8. Other wireless devices such as the wireless PDA 10 may also be connected to the network 14 via the wireless access point 8. Additional systems, including the camera 12, wireless PDA and wireless access point 11 may also be included. Remote monitoring stations 46 and 6, each with a dedicated server 5 and 7 are also connected to the network 14, which may be, for example, a local area network or LAN. The system may also be connected to a wide area network (WAN) or to the Internet, as indicated by line 21 and network 15. Additional hardwired cameras 3 and other components, including the wireless monitor 19 and server 20 connected via the wireless access point 18, and the wired monitor station 16 and server 17 may be connected anywhere on the Internet. In the preferred embodiment, the digitized IP video signal is introduced into the network 14 and then transmitted to the various collection components. A remote PC or other processor or server receives the transmitted signals and generates an output to be displayed on one or more monitors. The transmitted signal is also transmitted to an archival server for various functions as described in the prior incorporated applications. The signals may be also be stored for archival purposes on suitable storage devices such as the disk or tape.

Typically, a number of cameras are disposed around a facility to be monitored. Each camera produces a video signal representing the scene of interest. The digitized, compressed, video transmitted over the network may be selectively viewed on any of the various monitors connected to the network system, and/or may be received by the networked server for storage, analysis, and subsequent retrieval. The system supports multiple simultaneous viewing stations since the video is networked. The comprehensive signal is sent to each of the multiple viewing stations and may be independently manipulated at each station.

The various cameras are specialized according to their application. In particular, cameras viewing confined spaces may be hard mounted in some fixed, unmovable orientation, and may use a lens with a fixed F-number. Other cameras may view a large area, and require a remotely controlled steerable mount, and possibly a lens with variable F-number.

In summary, FIG. 1 expands upon the extent of the surveillance network, and points out- explicitly- the variety of apparatus that may be employed in the network. In FIG. 1, Network 14 is a modern LAN and/or WAN preferably passing traffic preferably using an IP protocol. Cameras 1 and 2 produce digital, compressed video data, preferably using MPEG or Wavelet encoding. The video thus produced may be displayed on monitor 5 (and 7) attached to monitor station 4 (and 6). The network may have ‘wireless’ extensions using IEEE 802.11 or other suitable wireless protocol. For example, Network 14 has attached one or more Wireless Access Points 8 and 11, which provide to wireless devices such as Wireless cameras 9 and 12, or to wireless PDA's 10 and 13. The PDA's may function as mobile Monitor Stations, as substitutes for the ‘fixed’ Monitor Stations 4 and 6.

Additionally, Network 14 may route selected data streams to a separate Network 15. This Network may be simply a (logical) extension of Network 15, or may be a wider network such as the Internet. This network may employ devices similar to network 14. For example, network 15 also contains a camera 3, Monitor Station 16 with monitor 17, and a Wireless Access Point 18 for communication with Wireless Monitor Station 19 and monitor 20.

As described, the invention supports a distributed network with one or more cameras and viewing stations. It should be noted in particular that the invention relies heavily on more modern LAN/WAN network topologies, such as IEEE 802.3 Ethernet, IEEE 802.11 Wireless Ethernet, and the like. In modern implementations, these networks convey data traffic using a variety of routable data protocols, including TCP/IP, Multicast UDP, and the like.

### Dynamic Control Panel Presentation and Updating

Note that there may be more than one viewing station viewing any given facility at any given time, and note the need for all such viewing stations to maintain a current, real-time depiction of the status of the various cameras. For example, when a person at a viewing station pans or tilts any given camera, the graphical camera icon on all viewing stations, network-wide, must move accordingly. Note that this network-wide real-time update of graphical camera data applies to other camera information., including:

The person currently controlling the camera.

The camera's current zoom position.

The camera's current pan position, either graphical or in a numeric ‘degrees’ format.

The camera's current tilt position, either graphical or in a numeric ‘degrees’ format.

The camera's current movement status; i.e., the camera icon or numeric status display is made to flash when the camera is being controlled.

The camera's color, i.e., the camera icon or numeric readout is rendered in a distinct color when idle, under some viewer's active control, or when the camera is automatically responding to an alarm.

In the invention, such information is continuously maintained, at all viewing stations network-wide, preferably using Multicast/UDP or TCP/IP protocols. Specifically, this means that when one or more of these parameters change, that change is reflected on all viewing stations. For example, if a new person assumes ‘ownership’ of the camera, that information is updated, in real-time, on all viewing stations, network-wide.

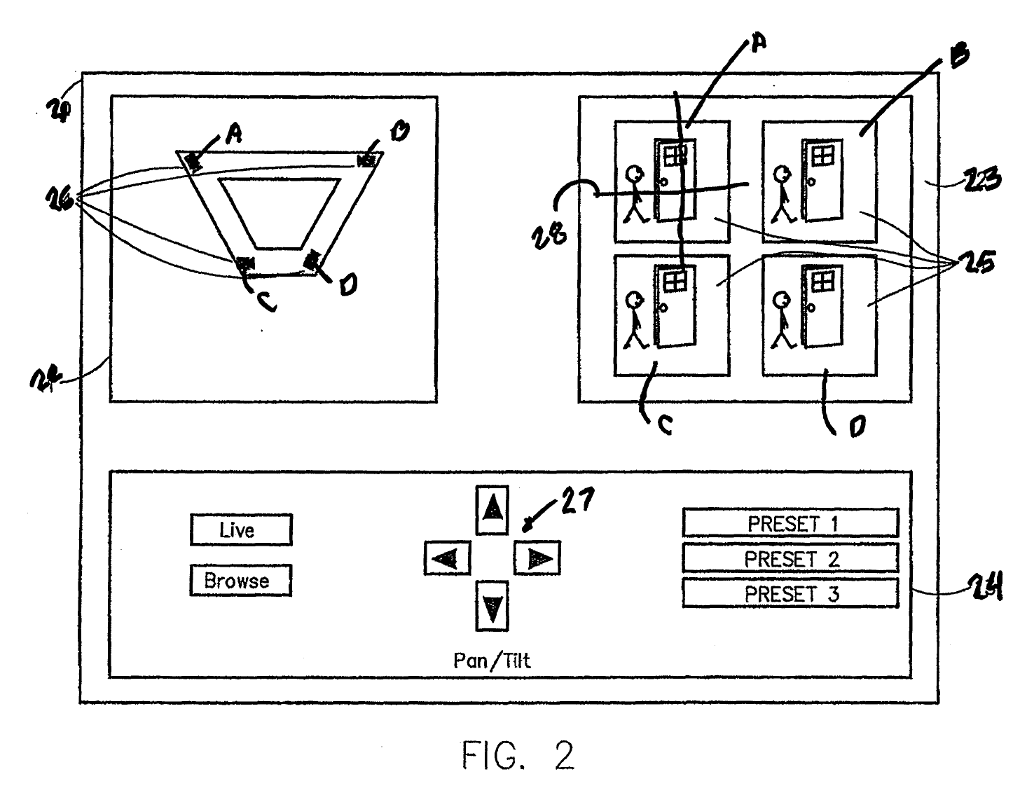

FIG. 2 illustrates a representative Graphical User Interface (GUI) as displayed at one of the operator's consoles. Application window 21 is divided into several specialized regions: a map section 22, a display section 23, and a controls section 24. The map contains a collection of camera icons 26, which depict the location and orientation of the available cameras. The display section contains one or more video ‘tiles’ 25, which display video from selected cameras. The display section can be configured by the operator as an array of 4×4 camera displays, or as a 3×3, 2×2, or a single full-pane camera display. The controls section provides a context-sensitive series of operator controls, including camera controls, archive browse controls, pan/tilt controls, system alarm controls, and the like. The map permits the user to determine the precise location and view of each of the plurality of cameras as indicated by the icons 26. There is a one-to-one correlation between the icons A, B, C, D and the corresponding display panel A, B, C, D. As more cameras are deployed, selected of the multiple cameras may be displayed.

An important feature of the subject invention is the ability to control pan/tilt/zoom capability of each adjustable camera directly at the GUI using a mouse and point-and-click technology. This permits the user to view the camera and select various functions by first clicking on the appropriate icon 26, which brings the camera up on the display window 23. For example, to pan or tilt the camera, the appropriate arrow button 27 would be selected by placing the mouse icon on the arrow and clicking or holding down the left mouse button.

Since the camera is in real-time mode, but is slightly delayed due to signal processing, cross-hairs 28 are visible for aiming the camera directly in the view window. In the preferred embodiment of the invention, the user moves the cross hairs in the panel and the camera will follow the crosshairs signal until the camera is focused directly on the center of the crosshairs. This eliminates any over compensation which may be caused by the delayed camera reaction. The control panel may include various control functions such as “live” or “browse” for the selected camera, search functions and various presets.

In the preferred embodiment of the invention, it is desirable to display the name of the user who is moving (i.e. in control of) the camera at all sites. The animated camera icons are visible to all users regardless of who is in control of a camera at any point in time.

Also, in the preferred embodiment, the entire data stream is in IP protocol, permitting network wide access and distribution. However other protocols may be used without departing from the scope of the invention, for example Wireless 802.11 or other suitable protocols.

Network wide presets may be employed, for returning each camera to a home position as soon as a user is finished with a session. User controlled presets may be employed, wherein the cameras automatically move to the preset position as soon as a particular user gains control. It is a feature of the invention that the presets will have user friendly names.

In the preferred embodiment of the invention each camera may be controlled by a joystick, the mouse or by the keyboard. Touch screen technology may also be employed.

In the scan mode of the camera, the icon tracks the direction of the camera. In addition, the icon tracks and displays on a network wide basis:

Zoom Position

Pan Position

Tilt Position

Readouts Degrees for Tilt

Readout in Degrees for Pan

Compass Style Readout for Pan

Flashing while moving

Different Color when “under the control” of someone

Different Color when responding to an alarm Display of Name of User “in control”

### Techniques for Immediate Control Presentation

When a camera is selected for viewing, a variety of related data is required to support the various camera controls. For example, the camera's current settings for brightness, contrast, or zoom are required to support an accurate set of camera controls on the user's screen. Some such controls may exist on some cameras, but not others. For example, some cameras may be equipped with a Pan/Tilt mount, and others not. There is thus a need to transfer data descriptive of the camera, to the user's display station when the camera is selected, in order to provide the user with a set of controls appropriate to the selected camera.

Due to network delays, the appearance of GUI-based camera controls may take several seconds to appear on the user's screen after a camera has been selected. The present invention reduces this delay. This is accomplished by loading said camera descriptive information into the user's viewing station at the time that the application is initially loaded, or at the time that an on-screen map depicting the available cameras at a selected location is initially loaded.

In addition, the present invention divides the various on-screen controls into two classes, those requiring immediate loading, and those not requiring immediate loading. For example, information requiring real-time access, such as the current zoom or brightness setting, typically require real-time access. Other camera descriptive data, such as the camera's assigned network address, or firmware revision, do not need immediate access. In the invention, descriptive data requiring immediate access are loaded into the user's application upon initial load. Other camera descriptive data not requiring immediate access, are not transferred to the user's application except on demand.

In an alternative embodiment of the present invention, the camera descriptive data is cached at a network server. Caching of said data reduces delays in loading the data into the user's application, since said data need not be requested and transferred over the entire camera-to-user network path. The server-to-user network path typically exhibits much shorter network latency. Moreover, time required for the camera to service a request for said configuration data is thereby eliminated.

In an alternative embodiment, the camera descriptive data is transmitted by the camera to a predetermined multicast address. User's viewing applications maintain a logical connection to said multicast address, and continually maintain an updated cache of all said descriptive data for all cameras. Again, User control response latency is thereby reduced.

### Joy-Stick User Interface

Prior disclosures have extensively described the use of a GUI and mouse to select and control cameras and their related functions, such as pan, tilt, focus, etc. It will be readily seen that the use of other pointing devices, such as joysticks or game controllers, are equivalent methods and do not depart from the scope and intent of the claims.

### Logging of Settings and Playback of Images/Video and Settings

In the present invention, said camera descriptive information, including the camera azimuth, elevation, zoom factor, etc, are time-stamped and stored in a database in a network server. Said descriptive information is of use during after-the-fact event reconstruction.

In the present invention, said camera descriptive information may selectively be displayed during subsequent perusal of the stored image database, as an aid to event analysis. Said camera position information may be stored as a separate, time-stamped file in the database. In an alternative embodiment, said data may be embedded into the stored image or video file, simplifying correlation of the camera control history with the image/video itself.

### Field of View Presentation

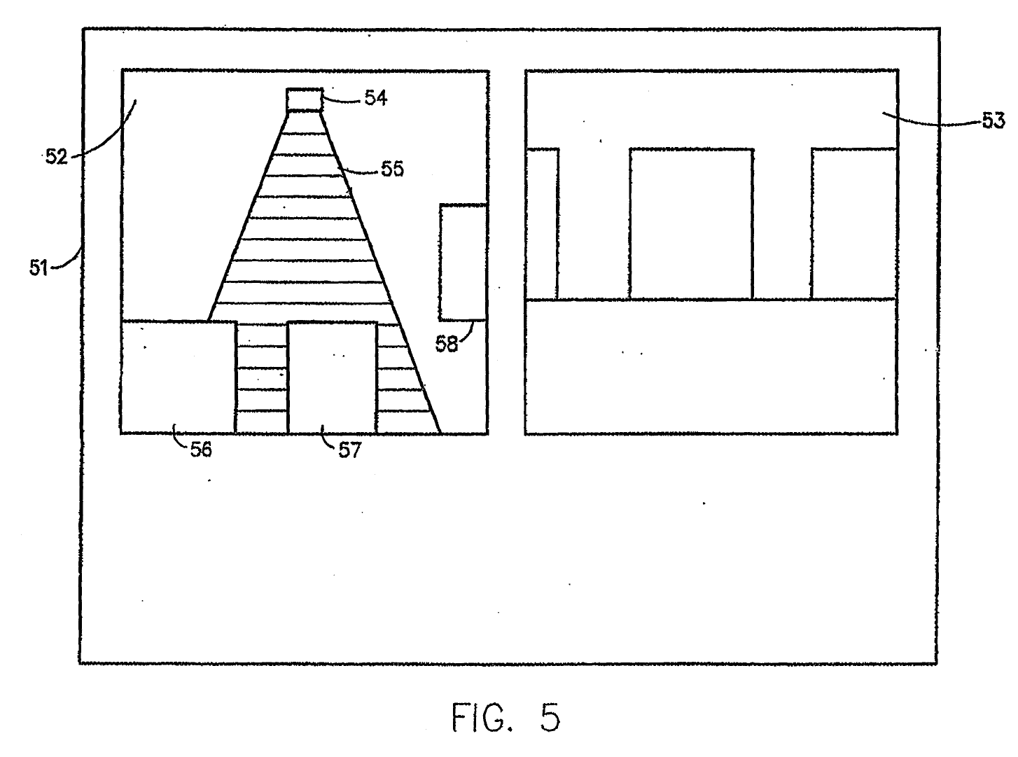

As previously discussed, cameras are depicted iconically on a map within the user's GUI. In FIG. 5, GUI 51 contains a facility map 52 and a display area 53 of the scene captured by a selected camera. In the facility map, camera 54 views a scene, depicted schematically, containing several rooms. Camera 54's field of view is depicted graphically by shaded area 55. As shown, several areas of the scene, such as those in rooms 56 and 57, contain walls which occlude the camera's view. Hence, these areas are not shaded, indicating that they are not within the camera's view.

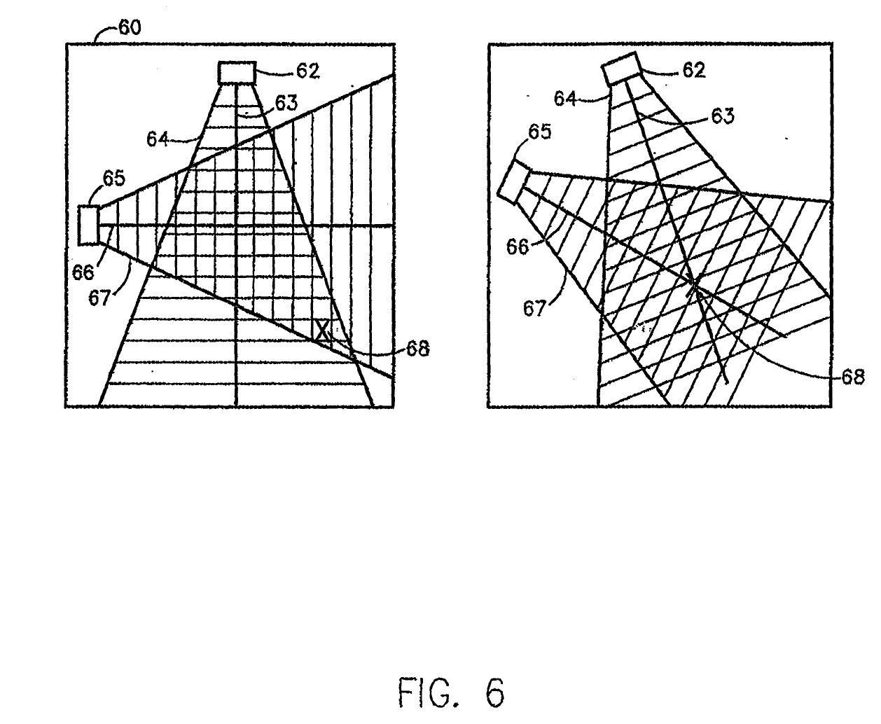

FIG. 6 illustrates several enhancements to the invention. GUI map 61 depicts a camera 62, and depicts it's field of view 64. Additionally, the camera's field-of-view centerline is shown on the map, as item 63. Likewise, camera 65 is shown with field-of-view 67 and field-of-view centerline 66. Such field-of-view centerlines are of use when controlling the camera.

In a further enhancement, a user selects a spot 68, using a mouse, joystick, trackball, game controller, or other suitable pointing device. The user's viewing application software determines the angular difference between the selected camera's field-of-view centerline and the selected spot 68. The software then commands the selected camera 68 to rotate as to center it's field-of-view upon the selected spot on the map. For instance, in FIG. 6, selected camera 62 is evidently pointed to the right of selected spot 68. The user application software detects the angular difference, and rotates camera 62 so as to align it's field-of-view upon the selected spot.

Note that this action need not be limited to one selected camera. As shown in FIG. 6, an additional camera 65 is positioned so as to be capable of viewing selected spot 68. Upon user command, both cameras 62 and 65 rotate so as to position their respective field-of-view centerlines upon the selected spot.

### Automatic Tilting, Panning, Zooming, Focusing, Light Level, and Other Adjustments

As discussed, a variety of camera functions are under user control. These functions include camera movement (Pan and Tilt), plus zoom, focus, brightness & contrast, and so on. Users may, for example, select a camera and control the camera pan or tilt, to view a selected area.

In an enhancement to the invention, such camera movements may be pre-defined and automated by an authorized user. An authorized user may, for example, define, to the camera, a left pan stop, a right pan stop, and optionally, a pan rate. Equivalently, a ‘pan center’ and ‘pan excursion’ position may be commanded. Either way, this sequence may then be invoked by a user, or may be automatically commanded by a network server based on time of day or time of camera inactivity.

Note that this pre-defined control sequence, or mode, may also include other camera control functions such as tilt, zoom, focus, or camera brightness.

These automatic pan controls are available to all authorized users on the network, and are subject to the usage arbitration rules defined for the network (see below). As previously defined, all map-based camera icons on the network are animated to reflect the camera's real-time position. Likewise, camera data such as pan position, tilt angle, zoom factor, and other camera information is likewise maintained on all networked user viewing stations. As described, these pre-defined pan/tilt/zoom modes may optionally be referred to by a predetermined ‘friendly’ name, allowing greater ease-of-use. For example, a mode may be defined wherein a cafeteria camera may pan/tilt/zoom to various entry doors, and dwell on each one for some predefined interval. This mode may be defined, for example, as “Cafeteria Tour’. Other users on the network may subsequently invoke that camera mode by selecting ‘Cafeteria Tour’.

### Integration of Presets with Other Sensors/Systems

Pre-defined camera movement modes, or simple preset positions, have been extensively described. Prior discussion has described use of these camera modes and presets by networked users, subject to user authorization. These modes and presets may, however, also be invoked by a network server in response to various other stimuli. For example, a cafeteria door may be equipped with a glass breakage detector. Said detector may be connected to a camera, and upon detection the camera may invoke a predefined mode or preset. Alternatively, the camera may, upon detection, inform a networked server, which in turn commands the camera to a predefined mode or preset.

Note that it is not necessary for the various sensors to connect directly to a camera. Or even to the networked server. Such sensors may belong to a separate security network. This separate security network may, upon detection of a significant event, inform the networked server or the camera itself, and thus command a predefined mode or preset.

### User Control Arbitration

The video surveillance network inherently supports multiple viewing stations. It is possible, and in fact likely, that several viewers will simultaneously view any particular camera. If the camera is equipped with a pan/tilt/zoom mount, then contention for control of the camera is inevitable. It is necessary to regulate access to camera control functions by some means.

Users desiring to control a camera must establish a communications session with the camera. When the user sends the camera a control session request, the user's authorization level is included in the message. Certain camera control functions, such as setting the camera's unique network address or turning the camera on and off, are reserved for users with sufficiently high authorization levels.

Cameras use these authorization levels to grant access to camera controls, and to resolve contention between users, as follows:

If a new user has a higher authorization level than an existing user, the new user is granted access to the camera control functions. The old user's access is terminated. Notification of this event is given to both users.

If the new user has lower access than an existing user, the new user's request is denied by the camera. The reason for denial is given.

If the new user has the same authorization level as an existing user, the new user's control session request is denied. In addition, certain automated camera control functions may conflict with user commands. For example, a camera may be configured. i.e., preset to pan, tilt, and zoom to a scene of a particular doorway when the door's sensor is activated. Automated camera commands such as this take precedence over user commands.

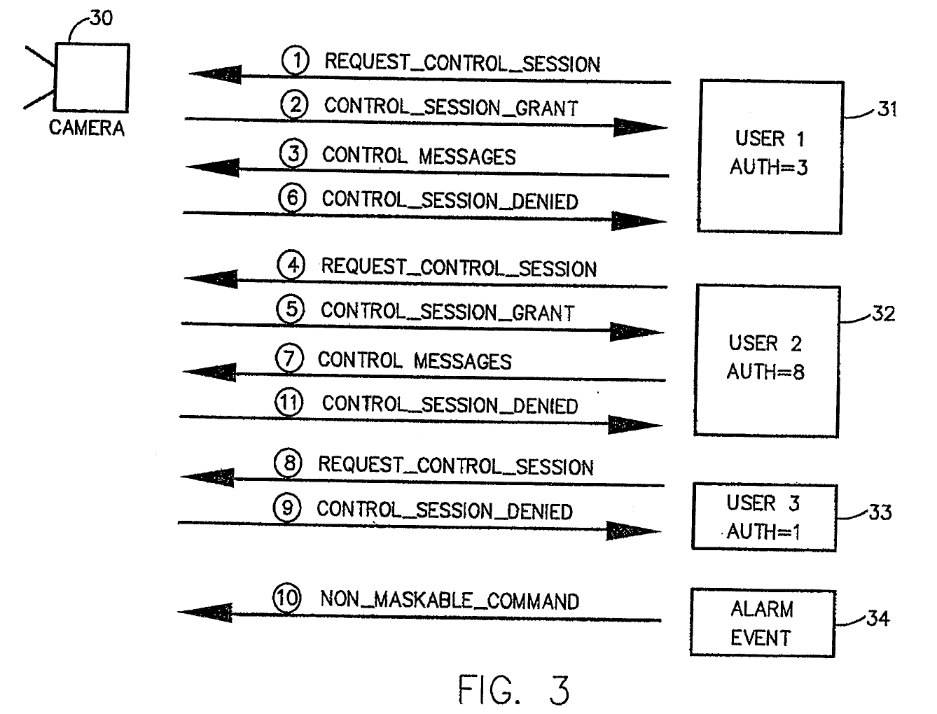

These rules are illustrated in FIG. 3. Users 31, 32, and 33 have been previously assigned authorization levels by a system administrator, and are required to log-on to an operator console in order to get access to the cameras on the network. Access to network resources is granted according to their authorization level.

User 31, with Authorization level 3, sends a Request Control Session message to camera 30. Since there are presently no other users with active control sessions with camera 30, the camera issues a Control Session Grant message to user 31. The user subsequently sends camera control messages as necessary to effect camera movement, such as pan or tilt.

User 2 wishes to gain control access to the camera. The user sends a Request Control Session message to the camera. Since user 2 has a higher authorization level than user 1, the camera responds with a Control Session Grant message to user 2. Since user 2 has effectively gained control of the camera, the camera denies control access to user 1, by sending a Control Message Denied message to user 1. User 2 is now able to send camera control messages as required.

Subsequently, User 3 wishes to control the camera. User 3 sends a Request Control Session message to the camera. Since User 3 has a lower authorization level than the current user, the camera responds to User 3 with a Control Session Denied message.

During User 2's control session with the camera, an external Alarm Event message 34 is sent to the camera. Such an Alarm Event may be generated by system sensors or servers, in response to stimuli of interest such as doors opening, glass breaking, and the like. The device recognizing the Alarm Event sends a Non Maskable Command to the camera. This command may, for example, cause the camera to aim at a predetermined point based on the nature of the Alarm Event. For example, the camera may be commanded to aim at a door when the door's sensor detects that the door has been opened.

Since the Non Maskable Command has overridden the active user's control session, the camera sends a Control Message Denied message to the currently active user.

Camera control sessions, once established, must not be allowed to become inadvertently permanent. A user might, for example, establish a camera control session, and then leave his workstation, forgetting that they had a camera control session established. To prevent this, cameras start a session timer immediately after granting a control session request. This time, upon expiration, terminates the established camera control session and informs the user of the control session termination. To prevent this, users must periodically send a control session request to the camera, to maintain control ‘ownership’ of the camera.

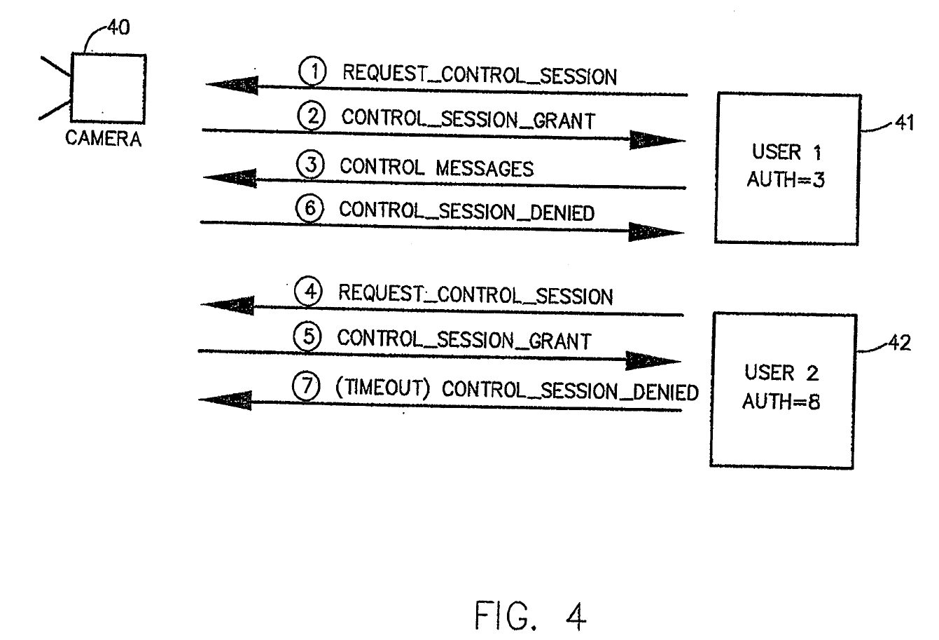

FIG. 4 illustrates the method. User 1 wishes to establish a control session with camera 40, and sends a Request Control Session message to the camera. If there are no other active users with higher authorization level, the camera responds with a Control Session Grant to the user. The user may then pass control messages to the camera.

Subsequently, User 2 wishes to gain control to camera 40 and sends a Request Camera Control message to the camera. Since User 2 has a higher authorization level than the current user, the camera sends User 2 a Control Session Grant message. The camera also issues a Control Session Denied message to User 1.

User 2 subsequently stops controlling the camera. The camera maintains a session timer, which upon expiration sends a Control Session Denied message to User 2, the currently active user.

### Network-wide Animated Icons

As shown in FIG. 2, operator consoles employ a series of camera icons, overlaid on a map, to indicate camera locations. The camera icons are typically directional, schematically depicting a camera and lens, to indicate their orientation. This is useful, in that it assists the user in selecting a camera to view. A hallway intersection, for example, may be equipped with two or more cameras to provide coverage of different hallway sections. Since the icons depict the camera's direction, a user can easily select a camera for any desired view.

While useful, this feature is complicated when movable cameras are employed. A camera may be rotated to some direction different from the direction indicated by the camera icon displayed on the viewer's screen.

In the invention, the camera icons are designed to rotate, as necessary, to maintain a faithful representation of the camera's real-time direction. Further, since the cameras are networked and thus viewable by more than one user, the invention updates and maintains the icon directions on all operator consoles on the network.

In the preferred embodiment, each camera will return to a home or preset position once the session has been terminated for a specified period of time.

At the operator's console, cameras which are equipped with pan/tilt/zoom mounts are made visually distinct. This is done in two ways: First, the video tiles in the display pane are ‘highlighted’ in a distinct color, to indicate they are pan/tilt equipped. Additionally, the camera icons on the map pane have a shape distinct from those cameras that are not so equipped. In addition, the video highlight and camera icon are made to blink when the associated camera is being controlled. This alerts all users that the camera is under remote control by a user on the system.

To invoke the camera controls, a user right-clicks either the camera icon, or right-clicks the camera's video tile. The right-click causes a camera control session request to be sent to the appropriate camera. If the request is successful, the user is granted camera control access. If unsuccessful, a pop-up message appears on the user's screen.

The network topology allows multiple viewers of any given camera's video. In fact, these viewers may be located on remote network segments. To support icon animation at these remote viewing consoles, some means is necessary to forward camera position information across the network. In the invention, cameras use a multicast protocol to forward this information to remote viewers on the network. Cameras periodically transmit various positional data, including azimuth and elevation, to a predetermined multicast address. At the viewing consoles, software establishes a communication session to that multicast group, and receives the positional data from the camera. The camera icons can thus be updated to indicate current position.

While certain embodiments and features of the invention have been specifically described herein, it should be understood that the invention includes all modifications and enhancements with the scope and spirit of the following claims.

What is claimed is:

1. A method for remotely controlling a camera on a network having simultaneous users with remote control access to the camera, the method comprising the steps of:
a. Identifying each user seeking access to and control of the camera;
b. Assigning a hierarchal authority to each user;
c. Granting control of the camera to the user with the highest authority.

2. The method of claim 1, wherein the first user to seek assess is granted control over users of equal authority.

3. The method of claim 1, wherein the user of highest authority is granted control at all times.

4. The method of claim 3, wherein the remaining user of highest remaining authority is granted access once a user of higher authority terminates a session.

5. The method of claim 1, including the step of canceling authority once the user with authority is dormant for a specified period of time.

6. The method of claim 1, including the step of defining the controlled camera with an icon and a graphic user interface provided to all users.

7. The method of claim 6, wherein the icon points in the direction of the camera.

8. The method of claim 1, including the step of returning a camera to a preset condition once a control session is terminated.

9. The method of claim 1, wherein the camera includes pan/tilt/zoom capability.

10. The method of claim 9, including the step of controlling the camera using point-and-click technology on a graphical user interface.

11. The method of claim 10, wherein including the step of displaying the camera data in a video panel on the graphical user interface.

12. The method of claim 11, including the step of defining a target on the video panel and the further step of activating the camera to hone in on the target.

13. A method for remotely controlling a camera with pan/tilt/zoom features on a network having simultaneous users with remote control access to the camera, the method comprising the steps of:
a. controlling the camera using point-and-click technology on a graphical user interface;
b. displaying the camera data in a video panel on the graphical user interface;
c. Activating the camera to hone in on the target.

14. The method of claim 13, further comprising the steps of:
a. Identifying each user seeking access to and control of the camera;
b. Assigning a hierarchal authority to each user;
c. Granting control of the camera to the user with the highest authority.

15. The method of claim 1, including the step of returning a camera to a preset condition once a control session is terminated.

16. A method for controlling a tilt/pan/zoom camera from a remote location over an IP network, the method comprising the steps of:
a. selecting a camera to be controlled;
b. highlighting the camera on a graphic user interface;
c. managing the camera using point-and-click technology.

17. The method of claim 16, including the steps of selecting and controlling legacy sensors in combination with the camera.

18. The method of claim 17, wherein the legacy sensors are responsive to an event and wherein the legacy sensor activates a camera in response to the event.

19. The method of claim 18, wherein the selecting step is controlled by the event.

20. The method of claim 18, including the step of aiming the camera at the sensor in response to the event.

21. The method of claim 20, including the step of returning the camera to a home position upon completion of the event.
